(19) United States
(12) Patent Application Publication
(10) Pub. No.: US 2005/0275865 A1
(43) Pub. Date: Dec. 15, 2005

(54) Printing system and method thereof

(76) Inventor: Sung-myun Lee, Anayng-si (KR)

Correspondence Address: STANZIONE & KIM, LLP, 919 18TH STREET, N.W., SUITE 440, WASHINGTON, DC, 20006, US

(21) Appl. No.: 11/151,431

(22) Filed: Jun. 14, 2005

(30) Foreign Application Priority Data
Jun. 15, 2004 (KR) 2004-44134
Jul. 26, 2004 (KR) 2004-58375

(51) Int. Cl. G06F 15/00

(52) U.S. Cl. 358/1.13

(57) ABSTRACT

A printing system and a printing method. A host of the printing system includes an input unit to receive a request command to set an overlay function with respect to a target document, and a printer driver unit to determine whether a work environment of the target document matches a work environment of an overlay image when the request command to set the overlay function is received, and to match work environments the target document and the overlay image when the request command is received. Accordingly, a user is not required to store work environment information, and the work environments of both the target document and the overlay image are automatically matched with each other.

### CROSS-REFERENCE TO RELATED APPLICATIONS

This application claims benefit under 35 U.S.C. § 119 from Korean Patent Application Nos. 2004-44134, filed on Jun. 15, 2004, and 2004-58375, filed on Jul. 26, 2004, the contents of which are incorporated herein by reference in their entirety.

### BACKGROUND OF THE INVENTION

1. Field of the Invention

The present general inventive concept relates to a printing system and a printing method, and in particular, to a printing system to overlay-print a predetermined document when a desired document is printed, and a printing method using the same.

2. Description of the Related Art

In general, an overlay function prints a desired document (hereinafter, referred to as ‘target document’) using a printing device by loading and applying an overlay image having a specific pattern or image as a background of the target document. The overlay image is typically a default image or an image that is stored after being created (or modified) using an application program.

FIG. 1 is a flow chart illustrating a conventional method of using the overlay function to print the target document.

First, a user creates (or modifies) a document using an application program running on a host device such as a computer. The user then inputs a user command to the application program in order to print the target document from a printing device such as a printer (S10). When the user command is received, an application program processing unit transfers the user command and a file containing information about the target document (hereinafter, it will be referred to as “printing file”) to a printer driver unit of the printing device through a Graphic Device Interface (hereinafter, referred to as “GDI”). The printer driver unit of the printing device then converts the user command and the printing file received through the GDI into printer command types that can be interpreted by the printing device (S11). The printer driver unit then determines whether the overlay function is set by the user (S12).

When the printer driver unit determines that the overlay function is not set, printer commands associated with the target document are transferred to the printing device, are rendered, and are printed on a sheet (S14, S15).

On the other hand, when the printer driver unit determines that the overlay function is set, the printer driver unit loads printer commands associated with an overlay image selected from among stored overlay images and combines the printer commands associated with the overlay image with the printer commands associated with the target document to generate combined printer commands (S13). The combined printer commands are then transferred to the printing device and are rendered to be printed on a sheet (S14, S15).

However, the conventional method of using the overlay function to print the target document has and/or causes the following problems.

First, a user may obtain a result that is different from what the user desires when a resolution of the overlay image is different from a resolution of the target document. For example, when the overlay function is applied to print the overlay image having a resolution of 1200 dots per inch (dpi) and the target document having a resolution of 600 dpi, the overlay image is printed to have a width and a length that are twice as large as an actual size of the overlay image. Conversely, when the overlay function is applied to print the overlay image having a resolution of 600 dpi and the target document having a resolution of 1200 dpi, the overlay image is printed to have a width and a length that are one half as large as the actual size of the overlay image.

Second, when a size of the overlay image does not match a size of the target document, the user may obtain a result that is different from what the user desires. For example, when the overlay function is applied to print the overlay image having a “letter” sheet size and the target document having an “A4” sheet size, the overlay image loses a portion thereof with respect to the target document in a widthwise direction.

In addition, the conventional method of applying the overlay function to print the target document, as described above, does not allow a user to apply the overlay function when a number of pages of the overlay image (hereinafter referred to as “overlay page(s)”) is more than one and a number of pages of the target document (hereinafter referred to as “target page(s)”) is also more than one. In other words, every image of the overlay pages is overlapped together to be printed on each target page when the overlay function is applied.

Accordingly, the user is required to repeatedly designate one overlay page for each target page for printing when a plurality of overlay pages of the overlay image are overlapped with a plurality of target pages of the target document. However, this is burdensome to the user.

### SUMMARY OF THE INVENTION

The present general inventive concept provides a printing system which is capable of comparing a work environment of an overlay image with a work environment of a target document and modifying one of the work environments such that the work environment of the target document matches the work environment of the overlay image when the overlay image is overlapped with the target document for printing. A printing method using the same is also provided.

The present general inventive concept also provides a printing system which allows one or more pages of an overlay image to be applied to one or more pages of a target document when the one or more overlay pages of the overlay image are overlaid on a plurality of target pages of the target document for printing, and a printing method using the same.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a printing system having a host and a printing apparatus to print a target document created by the host. The host comprises an input unit to receive a request command to apply an overlay function with respect to the target document, and a printer driver unit to match work environments of the target document and an overlay image when the request command is received.

The printer driver unit can determine whether the work environment of the target document matches the work environment of the overlay image and can compensate the work environment of the overlay image when the work environments of the overlay image and the target document do not match each other.

The work environments may include at least one of a resolution and a size.

The overlay image may be created in an application program in the host. The printer driver unit may include an overlay file processing unit to process information about the work environments when the overlay image is stored.

The printer driver unit may include an overlay scaling unit to calculate a scaling coefficient to compensate for a mismatch between the work environments of the target document and the overlay image, and a printer driver control unit to determine whether the work environment of the target document matches the work environment of the overlay image, to control the overlay scaling unit to calculate the scaling coefficient upon a determination of a mismatch, and to adjust one of the work environments of the target document and the overlay image according to the calculated scaling coefficient.

The work environments may comprise a resolution, and the calculated scaling coefficient may comprise a dpi scale factor. The dpi scale factor can be calculated according to the following equation:
dpi scale factor=overlay dpi+job dpi
where the overlay dpi represents a resolution when the overlay image is created, and the job dpi represents a resolution when the target document is created.

The work environments may comprise a size, and the overlay scaling unit may calculate a paper scale x factor, which is an x axis scaling coefficient, and a paper scale y factor, which is a y axis scaling coefficient, according to the following equations:
paper scale x factor=overlay paper x width−job paper x width
paper scale y factor=overlay paper y width+job paper y width
where the overlay paper x width represents an x axis size when the overlay image is created, the overlay paper y width represents a y axis size when the overlay image is created, the job paper x width represents an x axis size when the target document is created, and the job paper y width represents a y axis size when the target document is created.

The work environments may comprise a size and a resolution, and the overlay scaling unit may calculate a scale x factor, which is an x axis scaling coefficient, and a scale y factor, which is a y-axis scaling coefficient, according to the following equations:
scale x factor=(overlay dpi+job dpi)×(overlay paper x width job paper x width)
scale y factor=(overlay dpi+job dpi)×(overlay paper y width job paper y width),
where the overlay dpi represents a resolution when the overlay image is created, the job dpi represents a resolution when the target document is created, the overlay paper x width represents an x axis size when the overlay image is created, the overlay paper y width represents a y axis size when the overlay image is created, the job paper x width represents an x axis size when the target document is created, and the job paper y width represents a y axis size when the target document is created.

The foregoing and/or other aspects of the present general inventive concept are also achieved by providing a printing method comprising converting a target document into a printer command associated with the target document that is capable of being interpreted by a printing apparatus when a request command to print the target document is received, compensating one of the printer command associated with the target document and a printer command associated with an overlay image to match work environments of the target document when an overlay function is set with respect to the target document and the overlay image, and combining the printer command associated with the target document and the printer command associated with the overlay image to generate a combined printer command.

The compensating of the one of the printer command associated with the target document and the printer command associated with the overlay image may comprise determining whether the overlay function is set, determining whether the work environments of the target document and the overlay image match each other upon a determination that the overlay function is set, calculating a scaling coefficient to match the work environments of the target document and the overlay image upon a determination that the work environments of the target document and the overlay image do not match, and compensating the one of the printer command associated with the target document and the printer command associated with the overlay image according to the calculated scaling coefficient.

The method may further comprise performing a printing process on one or more sheets of a print medium according to the generated combined printer command.

The foregoing and/or other aspects of the present general inventive concept are also achieved by providing a printing system comprising a host and a printing apparatus to print a target document having a plurality of pages created in the host. The host comprises an input unit to receive a request command to apply an overlay function with respect to the target document, a storage unit to store a page mapping information about a plurality of pages of an overlay image to be applied to each page of the target document, and a printer driver unit to combine a printer command for each of the plurality of pages of the target document with a corresponding printer command of a plurality of pages of the overlay image according to the page mapping information to generate a combined printer command.

The printer driver unit may comprise a page mapping unit to map the plurality of pages of the overlay image to the plurality of pages of the target document, and a printer driver control unit to combine a plurality of printer commands of the corresponding plurality of pages of the target document with a plurality of printer commands of the plurality of mapped pages of the overlay image based on the mapping performed by the page mapping unit to generate the combined printer command.

The foregoing and/or other aspects of the present general inventive concept are also achieved by providing a printing method comprising converting a target document having a plurality of pages into a printer command capable of being interpreted by a printing apparatus when a request command to print the target document is received, determining page mapping information with respect to each page of the overlay image having a plurality of pages to be applied to each page of the target document when an overlay function is set with respect to the target document, combining a printer command of each page of the target document with a plurality of printer commands of the corresponding a plurality of pages of the overlay image according to the determined page mapping information to generate a combined printer command, and performing a printing process on one or more sheets of a print medium based on the generated combined printer command.

The generating of the combined printer command may comprise determining whether a current page of the target document matches a first page of the overlay image based on the page mapping information and combining a printer command of the first page of the target document with a command of the first page of the overlay image to generate a combined printer command for the current page upon a determination that the current page of the target document matches the first page of the overlay image.

The generating of the combined printer command further comprises determining whether a second page of the overlay image matches the current page of the target document upon a determination that the current page of the target document does not match the first page of the overlay image, and combining the printer command of the current page of the target document with a printer command of the second page of the overlay image to generate the combined printer command for the current page upon a determination that the current page of the target document matches the second page of the overlay image. The combined printer command may be generated to correspond to each page in the target document until a final page of the target document is reached. The method may further comprise combining all of the combined printer commands that correspond to each of the pages of the target document to generate a single combined printer command.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a flow chart illustrating a conventional method of using an overlay function to print a target document;

FIG. 2 is a block diagram illustrating a printing system according to an embodiment of the present general inventive concept;

FIG. 3 is a block diagram illustrating a printer driver unit of the printing system of FIG. 2;

FIG. 4 illustrates a data structure of an overlay file according to an embodiment of the present general inventive concept;

FIG. 5 is a flow chart illustrating a method of applying an overlay function to print a target document according to an embodiment of the present general inventive concept;

FIG. 6 is a block diagram illustrating a printing system according to another embodiment of the present general inventive concept;

FIG. 7 is a block diagram illustrating a printer driver unit of the printing system of FIG. 6;

FIG. 8 is a diagram illustrating one dimensional tables used to map pages of an overlay image and to pages of a target document according to an embodiment of the present general inventive concept; and

FIG. 9 is a flow chart illustrating a method of using an overlay function to print a target document according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

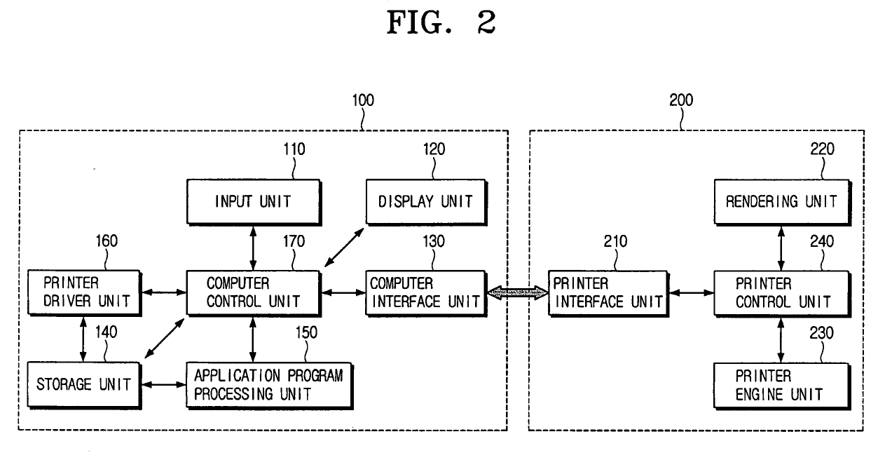

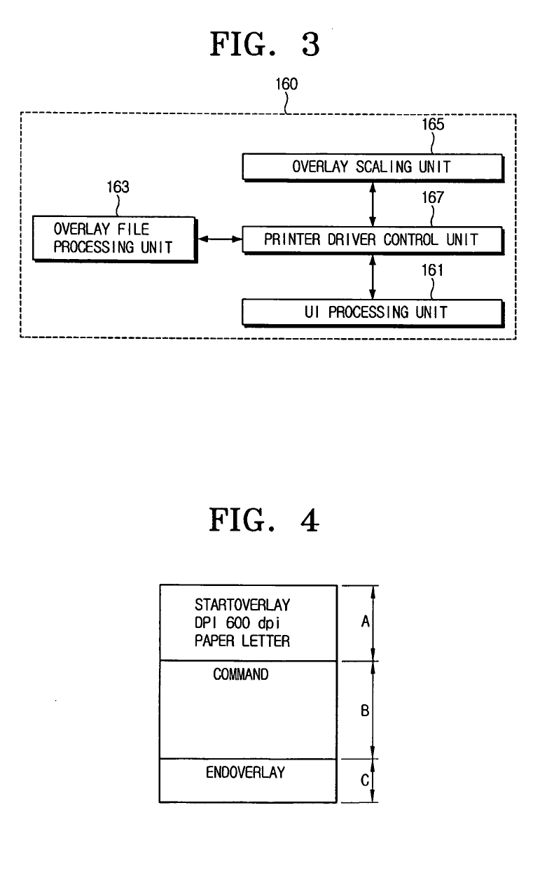

FIG. 2 is a block diagram illustrating a printing system according to an embodiment of the present general inventive concept, FIG. 3 is a block diagram illustrating a printer driver unit 160 of the printing system of FIG. 2, and FIG. 4 illustrates a data structure of an overlay file according to an embodiment of the present general inventive concept.

Referring to FIG. 2, the printing system includes a computer 100 and a printer 200. Other printing devices and hosts may alternatively be used, which perform the intended operations described herein.

A target document created (or modified) in the computer 100 is converted into printer commands capable of being interpreted by the printer 200 and is then transferred to the printer 200. The transferred printer commands can then be converted into bitmap data using a rendering process in the printer 200. The bitmap data can then be printed on one or more sheets of a print medium. Other processes may alternatively be used to convert the transferred printer commands into printable data. Alternatively, the conversion of the printer commands into printable data may be performed by the computer 100 and subsequently transferred to the printer 200.

Throughout this detailed description of the present general inventive concept the term “work environments,” as used with reference to particular documents, images, and files can be understood to refer to a resolution thereof, a size thereof, or other characteristics thereof that affect how the particular documents appear when printed.

The computer 100 according to various embodiments of the present general inventive concept may include an input unit 110, a display unit 120, a computer interface unit 130, a storage unit 140, an application program processing unit 150, the printer driver unit 160, and a computer control unit 170.

The input unit 110 receives user commands to set and/or select various functions supported by the computer 100. The user commands may include a print request command to print the target document, an overlay command to set the overlay function, and a selection command to select the overlay image. The input unit 110 may include, for example, a keyboard and/or a mouse. When various commands are input through the input unit 110, the computer control unit 170 may control internal components of the computer 100 based on the various commands.

The display unit 120 displays various application program user interfaces and printer driver user interfaces according to the control of the computer control unit 170. The display unit 120 can display the printer driver user interface, which can be used to set the overlay function, and the user may input the overlay command to set the overlay function based on the displayed printer driver user interface. In addition, at least one file list from which to select the overlay image can be displayed on the printer driver user interface such that the user may input the selection command to select the overlay image. The display unit 120 may comprise a monitor. Alternatively, other display devices may also be used as the display unit 120.

The computer interface unit 130 can be arranged to connect the computer 100 to external equipment (e.g., the printer 200). The computer interface unit 130 may comprise a parallel port, a Universal Serial Bus (USB) port, and/or a wireless port. The computer interface unit 130 is connected to the printer 200 and provides a passage therebetween along which data information associated with a printing process can be exchanged with the printer 200. Accordingly, the data information associated with the printing process is transceived via the computer interface unit 130. According to embodiments of the present general inventive concept, combined printer commands, which are combined from printer commands associated with the target document and printer commands associated with the overlay image, can be transferred to the printer 200 through the computer interface unit 130.

The storage unit 140 comprises a non-volatile memory in which an operating system, various application programs, and various data are stored to implement functions of the computer 100, and a volatile memory to temporarily store data that is produced during the control process and a printing process.

At least one overlay image may be stored as printer command types that can be interpreted by the printer 200 in a predetermined location of the non-volatile memory.

The application program processing unit 150 controls execution of various application programs stored in the non-volatile memory by executing the user commands according to control of the computer control unit 170. That is, the application program processing unit 150 allows various application program user interfaces to be displayed on the display unit 120 such that the overlay image and/or the target document can be created (or modified) using the various application programs.

The printer driver unit 160 converts the target document created (or modified) in an application program into printer commands capable of being interpreted by the printer 200 according to the control of the computer control unit 170. In addition, when the overlay command (i.e., overlay function setting command) is input by the user, the printer driver unit 160 applies the overlay function to the target document according to the control of the computer control unit 170.

Referring to FIG. 3, the printer driver unit 160 according to an embodiment of the present general inventive concept comprises a user interface (UI) processing unit 161, an overlay file processing unit 163, an overlay scaling unit 165, and a printer driver control unit 167.

The UI processing unit 161 allows a UI to be displayed on the display unit 120 according to the control of the printer driver control unit 167 when a UI displaying command is received through the input unit 110. In this case, a user setting option is applied during a printing process according to the control of the printer driver control unit 167 when various function setting commands associated with the printing process are selected in the UI.

The overlay file processing unit 163 processes each file when documents or images created (or modified) by various application programs are stored in the non-volatile memory as overlay files. The overlay files may include information about the corresponding overlay images.

According to various embodiments of the present general inventive concept, the overlay file processing unit 163 and the application program processing unit 150, allow various work environments, strings indicating start points and end points of overlay encapsulation, and printer commands associated with each overlay image to be stored in a data structure of the overlay file when each overlay image is stored. In other words, rather than only storing the printer commands associated with the overlay image, the work environment in which the overlay image is created (or modified) can also be stored along with the printer commands associated with the overlay image in the overlay file in accordance with the various embodiments of the present general inventive concept.

The data structure of the overlay file is illustrated in FIG. 4. The data structure of FIG. 4 can be divided into three regions. A STARTOVERLAY string indicating the start point of the overlay encapsulation and work environment information about the overlay image are stored in a region A. The work environment information may include size and resolution information. Printer commands associated with the overlay image are stored in a region B and an ENDOVERLAY string indicating the end point of overlay encapsulation is stored in a region C.

Referring to FIG. 3, the overlay scaling unit 165 calculates a scaling coefficient capable of compensating for a difference between the work environment of the overlay image and the work environment of the target document according to the control of the printer driver control unit 167.

When the work environment includes a resolution and the resolution of the target document is different from that of the overlay image, the overlay scaling unit 165 calculates a resolution scaling coefficient, namely a dpi scale factor, using [Equation 1] below.
dpi scale factor=overlay dpi+job dpi [Equation 1]
where the overlay dpi represents the resolution of the overlay image when the overlay image is created, and the job dpi represents the resolution of the target document when the target document is created.

In addition, when the work environment includes a size and the size of the target document is different from that of the overlay image, the overlay scaling unit 165 calculates size scaling coefficients, namely a paper scale x factor and a paper scale y factor using [Equation 2] below. In this case, the paper scale x factor is a scaling coefficient with respect to an x axis, and the paper scale y factor is a scaling coefficient with respect to a y axis.
paper scale x factor=overlay paper x width job paper x width [Equation 2]
paper scale y factor=overlay paper y width+job paper y width
where the overlay paper x width represents an x axis size when the overlay image is created, the overlay paper y width represents a y axis size when the overlay image is created, the job paper x width represents an x axis size when the target document is created, and the job paper y width represents a y axis size when the target document is created.

When the work environment includes both the resolution and the size, and when the resolution and the size of the target document are different from those of the overlay image, the overlay scaling unit 165 calculates scaling coefficients, namely a scale x factor and a scale y factor using the above-mentioned equations 1, 2, and [Equation 3] below. In this case, the scale x factor is a scaling coefficient with respect to an x axis, and the scale y factor is a scaling coefficient with respect to a y axis.
scale x factor=dpi scale factor x paper scale x factor [Equation 3]
scale y factor=dpi scale factor x paper scale y factor

The printer driver control unit 167 converts the target document and the overlay image into printer commands when the user sets the overlay function and inputs user commands for the target document. The printer driver control unit 167 also parses the printer commands. In addition, the printer driver control unit 167 according to an embodiment of the present general inventive concept may include a component that determines whether a parsing command corresponds to the target document or the overlay image according to an OVERLAYFLAG. The OVERLAYFLAG is initially set to 0. The OVERLAYFLAG is then changed to 1 when the printer driver control unit 167 parses the STARTOVERLAY string. The OVERLAYFLAG is then reset to 0 when the printer driver control unit 167 parses the ENDOVERLAY string. Accordingly, the printer driver control unit 167 can determine which file is being parsed and can interpret the parsing command to be the command of the overlay image when the OVERLAYFLAG is 1. In other words, printer commands that are converted by the printer driver control unit 167 can be associated with either the target document or the overlay image based on the value of the OVERLAYFLAG.

The printer driver control unit 167 adjusts the printer command associated with the overlay image to match the work environment of the overlay image with that of the target document when the work environment of the overlay image is different from that of the target document.

The printer driver control unit 167 reads out work environment information from the commands associated with the target document, and reads out work environment information from the printer commands associated with the overlay image. The printer driver control unit 167 then compares the work environment information associated with each of the target document and the overly image and determines whether they match each other. By way of example, when the work environment includes the resolution and the size, the printer driver control unit 167 compares and determines whether information about the resolution and the size of the target document matches that of the overlay image. When both sizes are the same but the resolutions are different from each other, the printer driver control unit 167 transmits difference information and the work environment information to the overlay scaling unit 165 such that the overlay scaling unit 165 can perform the operation described in the equation 1. When both resolutions are the same but the sizes are different from each other, the printer driver control unit 167 transmits difference information and the work environment information to the overlay scaling unit 165 such that the overlay scaling unit 165 can perform the operation described in the equation 2. When both the resolutions and the sizes of the target document and the overlay image are different from each other, the printer driver control unit 167 transmits difference information and the work environment information to the overlay scaling unit 165 such that the overlay scaling unit 165 can perform the operations described in the equations 1 to 3. Accordingly, a scaling coefficient (i.e., overlay scaling coefficient) can be calculated by the overlay scaling unit 165 according to the difference information and the work environment information to compensate the printer command associated with the overlay image for the difference in work environments.

The printer driver control unit 167 then applies the overlay scaling coefficient determined by the overlay scaling unit 165 to adjust the printer commands associated with the overlay image to compensate for the difference in work environments when the OVERLAYFLAG is set to 1 and both work environments (i.e., the work environments of the target document and the overlay image) are different from each other.

In addition, the printer driver control unit 167 may combine printer commands associated with the target document with those associated with the overlay image to generate combined printer commands when the overlay function is set. In accordance with the embodiments of the present general inventive concept, the printer commands associated with the overlay image are adjusted to allow the combined printer commands to be generated when both work environments (i.e., the work environments of the target document and the overlay image) are different from each other. Alternatively, the printer commands may be maintained separate from each other.

Referring to FIG. 2, the computer control unit 170 controls overall operations of the computer 100 using the operating system stored in the non-volatile memory.

The printer 200 includes a printer interface unit 210, a rendering unit 220, a printer engine unit 230, and a printer control unit 240. The printer control unit 240 controls overall operations of the printer 200 based on a control program stored in a non-volatile memory (not shown) of the printer 200.

The printer interface unit 210 is arranged to connect the printer 200 to external equipment (e.g., the computer 100). The printer interface unit 210 may include, for example, a parallel port, a USB port, and/or a wireless port. According to various embodiments of the present general inventive concept, the printer interface unit 210 is connected to the computer 100 to provide a passage therebetween along which data information associated with the printing process can be exchanged with the computer 100. Accordingly, the data information associated with the printing process can be transceived between the computer 100 and the printer 200 through the printer interface unit 210. According to various embodiments of the present general inventive concept, the combined printer commands, which are obtained by combining printer commands associated with the target document and printer commands associated with the overlay image, can be transferred from the computer 100 to the printer 200 via the printer interface unit 210.

The rendering unit 220 renders the combined printer commands transferred through the printer interface unit 210 and converts the combined printer commands into bitmap data according to the control of the printer control unit 240. According to various embodiments of the present general inventive concept, the combined printer commands transferred through the printer interface unit 210 are rendered by the rendering unit 220 and are converted into the bitmap data.

The printer engine unit 230 performs the printing process based on the bitmap data converted by the rendering unit 220 according to the control of the printer control unit 240.

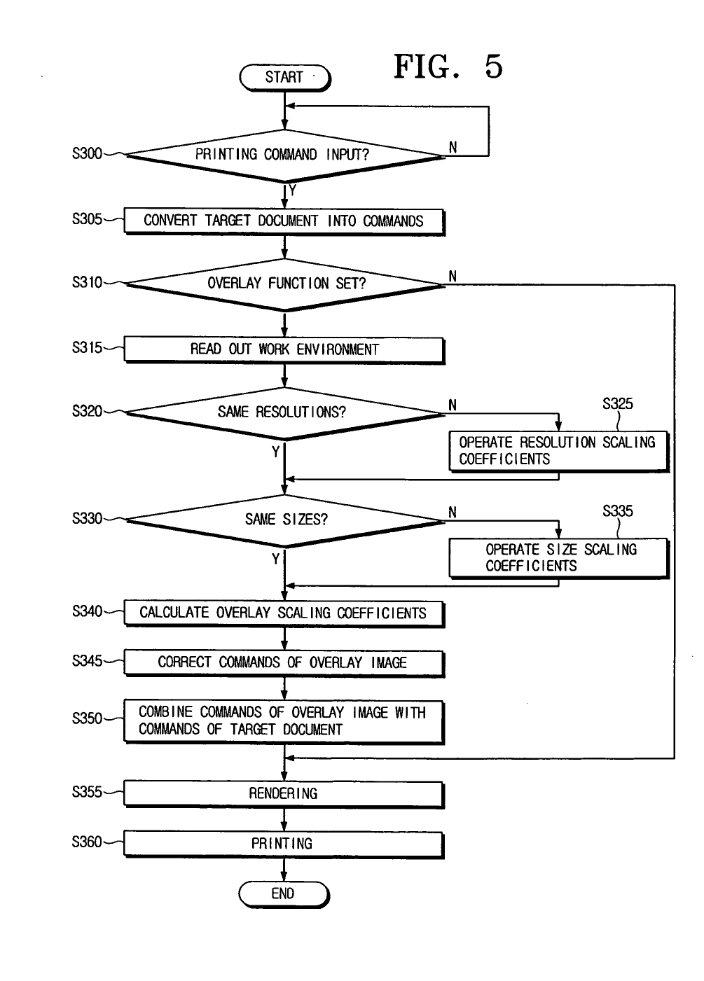

FIG. 5 is a flow chart illustrating a method of using the overlay function to print the target document according to an embodiment of the present general inventive concept.

Referring to FIGS. 2 to 5, a user can first create (or modify) the target document using an application program UI displayed on the display unit 120 of the computer 100. The user then inputs user commands (e.g., the overlay command, the selection command, and the print request command) to print the target document through the input unit 110 (operation S300). The printer driver unit 160 then receives the user commands and the target document through the GDI according to the control of the computer control unit 170, and converts the target document and the user commands into printer commands that are capable of being interpreted by the printer 200 (operation S305). The printer driver unit 160 also determines whether the overlay function is set for the target document according to the received user commands and the target document (operation S310).

When the overlay function is not set, the printer driver unit 160 controls the computer 100 to transfer the converted printer commands to the printer 200. The transferred printer commands are then rendered by the rendering unit 220 of the printer 200 (operation S355) and are converted into bitmap data to be printed on one or more sheets of a print medium (operation S360).

When the overlay function is set, the printer driver unit 160 reads work environment information associated with the target document and work environment information associated with the overlay image (operation S315).

The printer driver unit 160 then determines whether resolutions of the read work environments match each other (operation S320). When the printer driver unit 160 determines that both resolutions do not match each other, the overlay scaling unit 165 of the printer driver unit 160 calculates the resolution scaling coefficients capable of compensating for a resolution difference between the target document and the overlay image (operation S325).

In addition, the printer driver unit 160 determines whether both the target document and the overlay image sizes match each other (operation S330). When the printer driver unit 160 determines that both sizes do not match each other, the overlay scaling unit 165 of the printer driver unit 160 calculates the size scaling coefficients capable of compensating for a size difference between the target document and the overlay image (operation S335).

The printer driver unit 160 then calculates overlay scaling coefficients based on the calculated resolution scaling coefficients and/or the calculated size scaling coefficients (operation S340).

The printer driver unit 160 then adjusts (i.e., corrects) the printer commands associated with the overlay image according to the calculated overlay scaling coefficients (operation S345). The printer driver unit 160 then combines the corrected printer commands associated with the overlay image with the printer commands associated with the target document to generate the combined printer commands, and transfers the combined printer commands to the printer 200 (operation S350).

The combined printer commands are then rendered by the printer control unit 240 (operation S355), and are converted into bitmap data to be printed on the one or more sheets of the print medium (operation S360).

Although the embodiments of the present general inventive described above modify the work environment of the overlay image to match that of the target document, the work environment of the target document may alternatively be modified to match that of the overlay image. Additionally, it should be understood that the target document and the overlay image may include any printable file. For example, the overlay image may be a predetermined pattern file, an image, or a document.

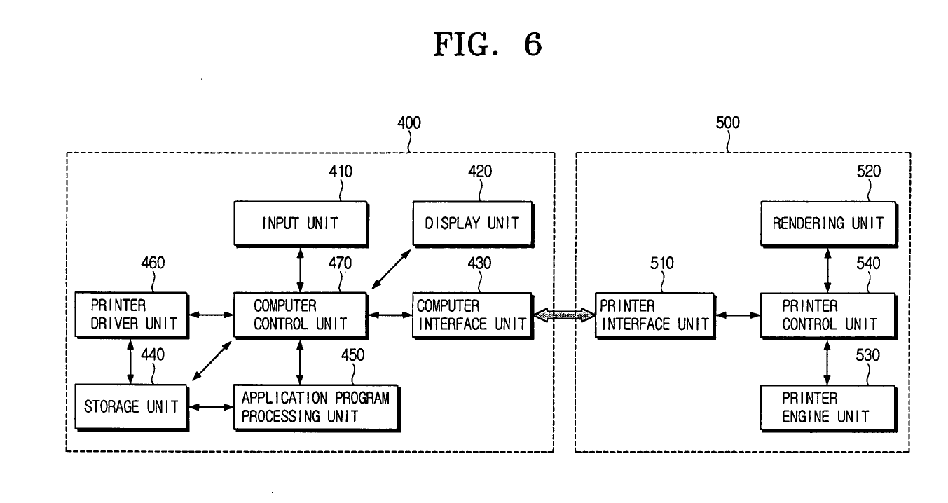

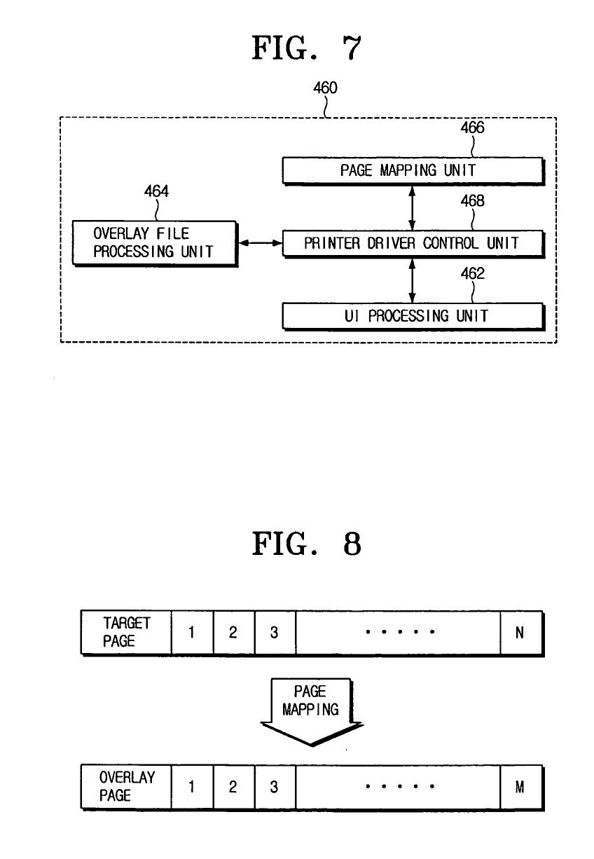

FIG. 6 is a block diagram illustrating a printing system according to another embodiment of the present general inventive concept, FIG. 7 is a block diagram illustrating a printer driver unit 460 of the printing system of FIG. 6, and FIG. 8 is a diagram illustrating one dimensional tables used to map pages of an overlay image to pages of a target document according to an embodiment of the present general inventive concept.

Hereinafter, it is assumed that the target document includes a plurality of target pages and that the overlay image includes a plurality of overlay pages. The present general inventive concept, however, is not limited in this regard. The target document and the overlay image may each include one or more pages.

Referring to FIG. 6, the printing system comprises a computer 400 and a printer 500. Other hosts and printing devices may alternatively be used.

The target document created (or modified) in the computer 400 is converted into printer commands capable of being interpreted by the printer 500 and is then transferred to the printer 500. The transferred printer commands can then be converted into bitmap data using a rendering process in the printer 500. The bitmap data can then be printed on one or more sheets of a print medium. Other processes may alternatively be used to convert the transferred printer commands into printable data. Additionally, the conversion of the printer commands into the printable data may be performed by the computer 400 and subsequently transferred to the printer 500.

The computer 400, according to various embodiments of the present general inventive concept, includes an input unit 410, a display unit 420, a computer interface unit 430, a storage unit 440, an application program processing unit 450, the printer driver unit 460, and a computer control unit 470.

The input unit 410 receives user commands to set and/or select various functions supported by the computer 400. The user commands include a print command to print the target document, an overlay command to set the overlay function, a selection command to select the overlay image, and a page designation command to designate an overlay page. The input unit 410 may include, for example, a keyboard and/or a mouse. The page designation command used to designate the overlay pages designates one overlay page in the overlay image on which each target page is applied.

The page designation command may be varied according to varying needs of different users. For example, one of the overlay pages may be applied to a first page of the target document and another one of the overlay pages may be applied to the rest of the pages of the target document. In another example, the page designation command may include an ordering function having an equation that calculates a ratio of the number of target pages to the number of overlay pages in order to sequentially map each overlay page to each target page. In other words, when using this function, a number of target pages is 8, and a number of overlay pages is 4, a first overlay page is applied to first and fifth pages of the target document, a second overlay page is applied to second and sixth pages of the target document, a third overlay page is applied to third and seventh pages of the target document, and a fourth overlay page is applied to fourth and eighth pages of the target document.

The computer control unit 470 controls internal components thereof according to the various user commands input through the input unit 410.

The display unit 420 displays various application program UIs, printer driver UIs, and other UIs according to the control of the computer control unit 470. The display unit 420 can display the printer driver UI, which can be used to set the overlay function, and the user may input the overlay command to set the overlay function based on the displayed printer driver UI. In addition, at least one file list from which to select the overlay image can be displayed on the printer driver UI such that the user may input the selection command to select the overlay image. In addition, the printer driver UI can display each page number of the target document and each page number of the overlay image such that the user may input the page designation command based on the displayed page numbers. The display unit 420 may comprise a monitor. Alternatively, other display devices may be used as the display unit 420.

The computer interface unit 430 can be arranged to connect the computer 400 to external equipment (e.g., the printer 500). The computer interface unit 430 may comprise a parallel port, a USB port, and/or a wireless port. The computer interface unit 430 is connected to the printer 500 and provides a passage therebetween along which data information associated with a printing process can be exchanged with the printer 500. Accordingly, the data information associated with printing process is transceived via the computer interface unit 430. According to various embodiments of the present general inventive concept, combined printer commands, which are obtained by combining printer commands associated with the target document and printer commands associated with the overlay image, can be transferred to the printer 500 via the computer interface unit 430.

The storage unit 440 comprises a non-volatile memory in which an operating system, various application programs, and various data are stored to implement functions of the computer 400, and a volatile memory to temporarily store data that that is produced during a control process and a printing process.

At least one overlay image may be stored in a predetermined location of the non-volatile memory as printer command types that can be interpreted by the printer 500. In addition, page mapping information based on the page designation command can also be stored in the predetermined location of the non-volatile memory. In this case, the page mapping information can include information that maps each overlay page of the overlay image to each target page of the target document.

The application program processing unit 450 controls execution of various application programs stored in the non-volatile memory by executing the user commands according to the control of the computer control unit 470. That is, the application program processing unit 450 allows various application program UIs to be displayed on the display unit 420 such that the overlay image and/or the target document can be created (or modified) using the various application programs.

The printer driver unit 460 converts the target document in an application program into printer commands capable of being interpreted by the printer 500 according to the control of the computer control unit 470. In addition, when the overlay command (i.e., overlay function setting command) is input by the user, the printer driver unit 460 applies the overlay function to the target document according to the control of the computer control unit 470.

Referring to FIG. 7, the printer driver unit 460 according to an embodiment of the present general inventive concept comprises a UI processing unit 462, an overlay file processing unit 464, a page mapping unit 466, and a printer driver control unit 468.

The UI processing unit 462 allows a printer driver UI to be displayed on the display unit 420 according to the control of the printer driver control unit 468 when a UI displaying command is received through the input unit 410. In this case, a user setting option is applied during a printing process according to the control of the printer driver control unit 468 when various function setting commands associated with printing process are selected in the printer driver UI.

The overlay file processing unit 464 processes each file when documents or images created (or modified) by various application programs are stored in the non-volatile memory as overlay files. The overlay files may include information about corresponding overlay images.

According to various embodiments of the present general inventive concept, the overlay file processing unit 464 and the application program processing unit 450, allow the number of overlay pages as well as printer commands associated with each overlay image to be stored in a data structure of the overlay file when each overlay image is stored. Each of the overlay pages of the overlay image can be stored as printer command types when the overlay image has a plurality of overlay pages.

In other words, rather than only storing the printer commands of the overlay image the overlay file, the number of pages of the overlay image can be stored together with the printer commands of the overlay image in the overlay file according to various embodiments of the present general inventive concept.

The page mapping unit 466 maps each target page to an overlay page based on the page designation command (i.e., overlay page designating command) received through the input unit 410. In other words, the page mapping unit 466 processes the overlay page to be applied to each target page by mapping the pages according to the control of the printer driver control unit 468.

A one dimensional table mapping as illustrated in FIG. 8 can be used to map the overlay pages of the overlay image to the target pages of the target document. Other mapping methods may alternatively be used.

A method of mapping the overlay pages of the overlay image to the target pages of the target document according to an embodiment of the present general inventive concept is described as follows. First to Mth overlay pages are first considered with respect to a first target page, and the overlay page to be applied to the first target page is determined. Upon this determination, the first target page is mapped to the corresponding overlay page. The determination procedure is based on the page designation command (i.e., overlay page designating command) input by the user. This procedure can be repeatedly carried out until the Nth target page is reached.

The printer driver control unit 468 converts the target document into printer commands when the user sets the overlay function and inputs user commands for the target document. In addition, the printer driver control unit 468 according to an embodiment of the present general inventive concept may include a component that determines whether a parsing command corresponds to the target document or the overlay image according to an OVERLAYFLAG. The OVERLAYFLAG is initially set to 0. The OVERLAYFLAG is then changed to 1 when the printer driver control unit 468 parses a STARTOVERLAY string. The OVERLAYFLAG is then reset to 0 when the printer driver control unit 468 parses an ENDOVERLAY string. Accordingly, the printer driver control unit 468 can interpret the parsing command to be the command of the overlay image when the OVERLAYFLAG is 1. In other words, printer commands that are converted by the printer driver control unit 468 can be associated with either the target document or the overlay image based on the value of the OVERLAYFLAG.

In addition, when the page designation command is input through the input init 410, the printer driver control unit 468 allows the page mapping information to be stored in the volatile memory according to the page designation command.

Once the target page(s) are mapped to the overlay page(s) by the page mapping unit 466, the printer driver control unit 468 combines printer commands associated with each of the overlay and target pages to generate a combined printer command for each page. The printer driver control unit 468 combines all combined printer commands for each page of the target document to generate combined printer commands for the target document.

The computer control unit 470 controls overall operations of the computer 400 using the operating system stored in the non-volatile memory.

The printer 500 comprises a printer interface unit 510, a rendering unit 520, a printer engine unit 530, and a printer control unit 540. The printer control unit 540 controls overall operations of the printer 500 based on a control program stored in the non-volatile memory (not shown) of the printer 500.

The printer interface unit 510 is arranged to connect the printer 500 to external equipment (e.g., the computer 400). The printer interface unit 510 may include, for example, a parallel port, a USB port, and/or a wireless module. According to various embodiments of the present general inventive concept, the printer interface unit 510 is connected to the computer 400 to provide a passage therebetween along which data information associated with the printing process of the printer 500 can be exchanged with the computer 400. Accordingly, the data information associated with the printing process can be transceived between the computer 400 and the printer 500 through the printer interface unit 510. According to various embodiments of the present general inventive concept, combined printer commands, which are obtained by combining printer commands associated with the target document and printer commands associated with the overlay image, can be transferred from the computer 400 to the printer 500 via the printer interface unit 510.

The rendering unit 520 renders the combined printer commands transferred through the printer interface unit 510 and converts the combined printer commands into bitmap data according to the control of the printer control unit 540. According to various embodiments of the present general inventive concept, the combined printer commands transferred through the printer interface unit 510 are rendered by the rendering unit 520 and are converted into the bitmap data.

The printer engine unit 530 performs the printing based on the bitmap data converted by the rendering unit 520 according to the control of the printer control unit 540.

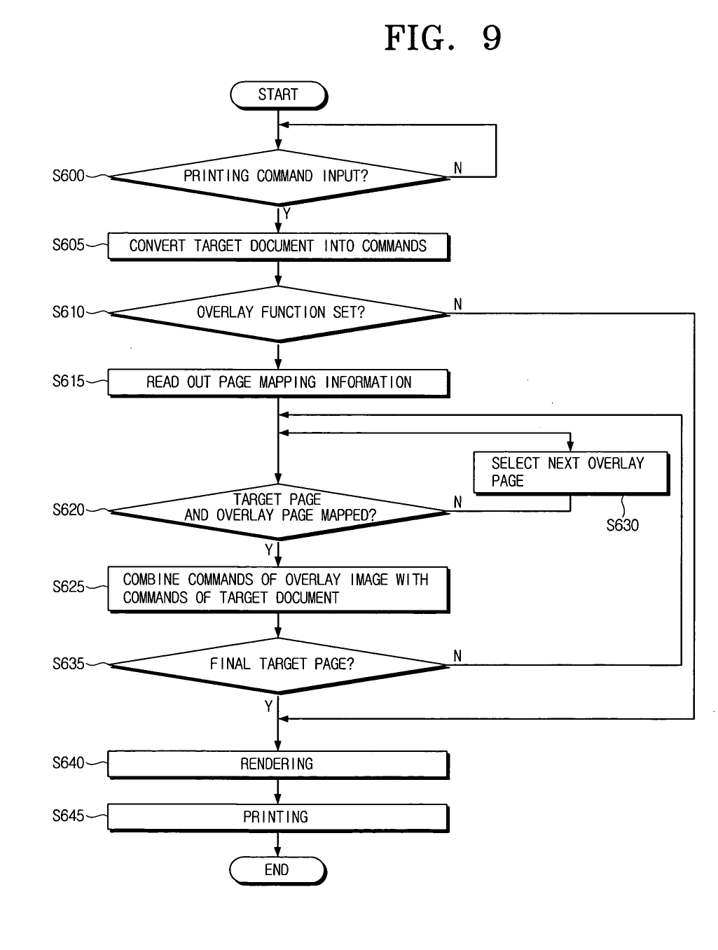

FIG. 9 is a flow chart illustrating a method of using the overlay function to print the target document according to another embodiment of the present general inventive concept.

Referring to FIGS. 6 to 9, the user can first create (or modify) the target document using an application program UI displayed on the display unit 420 of the computer 400. The user then inputs user commands (e.g., the overlay command, the selection command, the print request command, and the page designation command) to print the target document through the input unit 410 (operation S600). The printer driver unit 460 then receives the user commands and the target document through the GDI according to the control of the computer control unit 470, and converts the target document and the user commands into printer commands that are capable of being interpreted by the printer 500 (operation S605). The printer driver unit 460 determines whether the overlay function is set for the target document according to the transferred printer commands and the target document (operation S610).

When the overlay function is not set, the printer driver unit 460 controls the computer 400 to transfer the converted printer commands to the printer 500. The transferred printer commands are then rendered by the rendering unit 520 of the printer 500 (operation S640) and are converted into bitmap data to be printed on one or more sheets of a print medium (operation S645).

When the overlay function is set, the printer driver unit 460 reads out the page mapping information from the storage unit 440 based on the page designation command input through the input unit 410 (operation S615).

The printer driver unit 460 then determines whether a first target page matches a first overlay page based on the read page mapping information (operation S620). When the first target page is determined to match the first overlay page, the printer driver unit 460 combines the printer command associated with the corresponding target page and the printer command associated with the first overlay page to generate combined printer commands for each page (i.e., each matching set of target pages and overlay pages) (operation S625). When the first target page is determined not to match the first overlay page, the printer driver unit 460 selects a second overlay page which is next to the first overlay page (operation S630).

The printer driver unit 460 then determines whether the selected second overlay page matches the first target page (operation S620). Operations S630 to S625 can then be repeatedly executed based on the determination of operation S620. Thus, each target page can be matched with a corresponding overlay page according to the page mapping information. Additionally, the printer commands associated with each target page are combined with printer commands associated with each corresponding overlay page to obtain the combined printer commands for each page.

Operations S620, S625, and S630 are then repeatedly executed until a final target page of the target document is reached. In other words, the printer driver unit 460 generates a combined printer command for each page when the target pages match the overlay pages, and then determines whether a current target page is the final target page of the target document (operation S635).

When the current page is determined to be the final target page, the printer driver unit 460 may combine all of the combined printer commands for each page (i.e., that have been combined up to this point) into a single combined printer command, and transfers the single combined printer command to the printer 500.

The transferred combined printer command is then rendered by the printer control unit 540 (operation S640) and is then converted into bitmap data, which is printed on one or more sheets of the print medium (operation S645).

When the current page is determined not to be the final target page, the printer driver unit 460 re-executes operations S620, S625, S630, and S635.

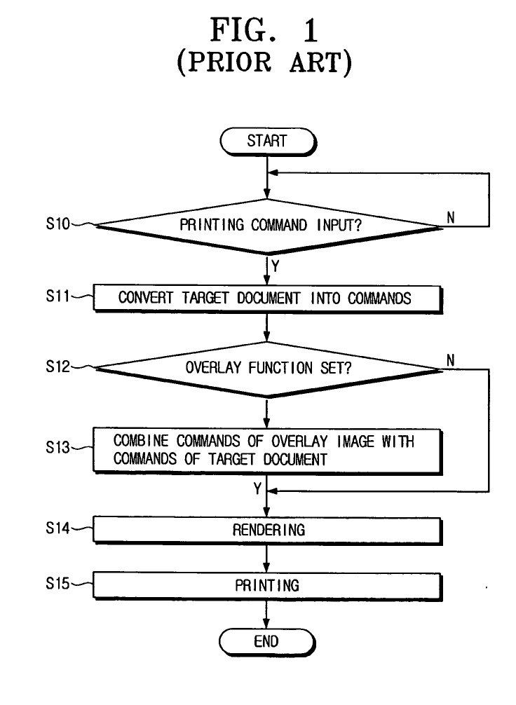

As described above, the conventional method of using the overlay function to print a desired document, illustrated in FIG. 1, requires the work environments of the overlay image and the target document to be stored when the user applies the overlay function to perform the printing process. However, according to various embodiments of the present general inventive concept, the user is not required to store every work environment, since both work environments of the target document and overlay images can automatically be matched with each other. This provides the user with convenience. In addition, according to the various embodiments of the present general inventive concept the overlay image need not be printed in order to determine the work environment of the overlay image. Accordingly, time, sheet, and ink can be saved.

As described above, in the conventional method of using the overlay function to print a desired document, illustrated in FIG. 1, when the target document having a plurality of pages and the overlay image having a plurality of pages are applied with the overlay function for each page, the user is required to designate the overlay page with respect to each target page in order to execute the printing process and to repeat the designation in order to output the desired document. However, according to various embodiments of the present general inventive concept, the user is not required to designate every overlay page for each target page in order to execute the printing process for each page. This provides the user with additional convenience.

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet). For example, the computer readable media may contain a printer driver program.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A printing system, comprising:
a host, comprising:
an input unit to receive a request command to apply an overlay function with respect to a target document, and
a printer driver unit to match work environments of the target document and an overlay image when the request command is received; and
a printing apparatus to print the target document created in the host.

2. The printing system as recited in claim 1, wherein the printer driver unit determines whether the work environment of the target document matches the work environment the overlay image and compensates the work environment of one of the target document and the overlay image when the work environments of the overlay image and the target document do not match each other.

3. The printing system as recited in claim 1, wherein the work environments comprise at least one of a resolution and a size.

4. The printing system as recited in claim 1, wherein the overlay image is created in an application program in the host, and the printer driver unit comprises an overlay file processing unit to process information about the work environment of the overlay image when the overlay image is stored.

5. The printing system as recited in claim 1, wherein the printer driver unit comprises:
an overlay scaling unit to calculate a scaling coefficient to compensate for a mismatch between the work environments of the target document and the overlay image; and
a printer driver control unit to determine whether the work environment of the target document matches the work environment of the overlay image, to control the overlay scaling unit to calculate the scaling coefficient upon a determination of a mismatch, and to adjust one of the work environments of the target document and the overlay image according to the calculated scaling coefficient.

6. The printing system as recited in claim 4, wherein the work environments comprise a resolution, and the calculated scaling coefficient comprises a dpi scale factor that is calculated based on the following:
dpi scale factor=overlay dpi job dpi
where the overlay dpi represents a resolution when overlay image is created, and the job dpi represents a resolution when the target document is created.

7. The printing system as recited in claim 4, wherein the work environments comprise a size and the overlay scaling unit calculates a paper scale x factor, which is an x axis scaling coefficient, and a paper scale y factor, which is a y axis scaling coefficient, according to the following:
paper scale x factor=overlay paper x width+job paper x width
paper scale y factor=overlay paper y width+job paper y width
where the overlay paper x width represents an x axis size when the overlay image is created, the overlay paper y width represents a y axis size when the overlay image is created, the job paper x width represents an x axis size when the target document is created, and the job paper y width represents a y axis size when the target document is created.

8. The printing system as recited in claim 4, wherein the work environments comprise a size and a resolution and the overlay scaling unit calculates a scale x factor, which is an x axis scaling coefficient, and a scale y factor, which is a y axis scaling coefficient, according to the following:
scale x factor=(overlay dpi+job dpi)×(overlay paper x width job paper x width)
scale y factor=(overlay dpi job dpi)×(overlay paper y width+job paper y width),
where the overlay dpi represents a resolution when the overlay image is created, the job dpi represents a resolution when the target document is created, the overlay paper x width represents an x axis size when the overlay image is created, the overlay paper y width represents a y axis size when the overlay image is created, the job paper x width represents an x axis size when the target document is created, and the job paper y width represents a y axis size when the target document is created.

9. The printing system as claimed in claim 1, wherein the request command comprises at least one of an overlay command to set the overlay function, a print request command to request a print operation, a selection command to select the overlay image from one or more overlay images, and a page designation command to provide information to map pages of the target document to pages of the overlay image when the overlay image and the target document include a plurality of pages.

10. A printing system having an overlay print function, comprising:
an interface to receive one or more overlay print request commands including a page designation command to map a plurality of pages of a target document to selected pages of an overlay image; and
a mapping unit to receive the page designation command, one or more printer commands associated with pages of the target document, and one or more printer commands associated with the selected pages of the overlay image and to combine the one or more printer commands associated with the pages of the target document with the one or more printer commands associated with the selected pages of the overlay image into one or more combined printer commands to instruct a printer to print the target document over the overlay image according to the mapped target pages.

11. A method of performing an overlay print, the method comprising:
receiving an overlay print request for a target file and an overlay file;
determining whether one or more print parameters of the target file and the overlay file are compatible for overlay printing; and
adjusting the one or more print parameters of one of the overlay file and the target file when the one or more print parameters of the target file and the overlay file are determined not be compatible for overlay printing.

12. The method as recited in claim 11, wherein the one or more print parameters comprise a work environment in which the target file and the overlay file are created.

13. The method as recited in claim 11, wherein the one or more print parameters comprise at least one of a resolution and a size, and the adjusting of the one or more print parameters comprises calculating a resolution scaling coefficient to scale the resolution of one of the target file and the overlay file when the resolution of the overlay file does not match the resolution of the target file, and calculating a size scaling coefficient to scale the size of one of the target file and the overlay file when the size of the overlay file does not match the size of the target file.

14. The method as recited in claim 11, further comprising:
providing one or more printer commands to instruct a printing apparatus to print the target file overlaid on the overlay file; and
printing the target file having the overlay file overlaid according to the one or more printer commands.

15. The method as recited in claim 11, further comprising:
storing at least one data structure including a first portion having information about a work environment of the overlay file and a second portion having one or more printer commands usable to instruct a printing apparatus to print the overlay image.

16. The method as recited in claim 11, further comprising:
controlling a printing apparatus by
determining one or more first printer commands to print the target file and one or more second printer commands to print the overlay file, and
modifying one of the one or more first printer commands and the one or more second printer commands to compensate for a difference in the one or more print parameters.

17. The method as recited in claim 16, wherein the overlay file is stored as an overlay data structure including a start point to identify a start of the overlay data structure, an end point to identify an end of the overlay data structure, work environment information about the overlay file, and the one or more second printer commands, and the determining of the one or more first printer commands and the one or more second printer commands comprises parsing the one or more first printer commands and the one or more second printer commands using an overlay flag having a value that depends on the start point and the end point of the overlay data structure to determine whether the one or more first printer commands or the one or more second printer commands is being parsed.

18. The method as recited in claim 11, wherein the overlay file includes a plurality of pages and the target file includes a plurality of pages, and the method further comprises:
receiving a page designation command relating each of the plurality of pages of the target file to a corresponding page of the overlay file;
determining mapping information according to the page designation command;
combining each of a plurality of printer commands associated with the plurality of pages of the target file with a printer command of the corresponding page of the overlay file to provide the plurality of combined printer commands that correspond to the plurality of pages of the target file to a print apparatus to perform the overlay print; and
performing the overlay print according to printer commands, wherein the overlay file includes a plurality of pages and the target file includes a plurality of pages.

19. The method as recited in claim 18, wherein a single printer command combined from the plurality of printer commands of the target file and the overlay file is provided to the printing apparatus.

20. The method as recited in claim 18, wherein the page designation command includes a single command.

21. A printing method, comprising:
converting a target document and an overlay image into printer commands capable of being interpreted by a printing apparatus when a request command to print the target document is received;
compensating one of the printer commands associated with one of the target document and the overlay image to match work environments of the target document and the overlay image when an overlay function is set with respect to the target document; and
combining the printer commands associated with each of the target document and the overlay image to generate a combined printer command.

22. The method as recited in claim 21, wherein the compensating of the one of the printer commands associated with one of the target document and the overlay image comprises:
determining whether the overlay function is set;
determining whether the work environments of the target document and the overlay image match each other upon a determination that the overlay function is set;
calculating a scaling coefficient to match the work environments of the target document and the overlay image upon a determination that the work environments of the target document and the overlay image do not match; and
compensating the one of the printer command associated with the target document and the printer command associated with the overlay image according to the calculated scaling coefficient.

23. The method as recited in claim 21, further comprising:
performing a printing process on one or more sheets of a print medium based on the generated combined printer command.

24. A printing system, comprising:
a host, comprising:
an input unit to receive a request command to apply an overlay function with respect to a target document having a plurality of pages,
a storage unit to store page mapping information about a plurality of pages of an overlay image to be applied to each page of the target document, and
a printer driver unit to combine a printer command for each of the plurality of pages of the target document with a printer command of a corresponding page of the overlay image according to the page mapping information to generate a combined printer command; and
a printing apparatus to print the target document created in the host according to the combined print command.

25. The printing system as recited in claim 24, wherein the printer driver unit comprises:
a page mapping unit to map the plurality of pages of the overlay image to the plurality of pages of the target document; and
a printer driver control unit to combine a plurality of printer commands of the corresponding plurality of pages of the target document with a plurality of printer commands of the plurality of mapped pages of the overlay image based on the mapping performed by the page mapping unit to generate the combined printer command.
